(19) United States
(12) Patent Application Publication
(10) Pub. No.: US 2016/0048804 A1
(43) Pub. Date: Feb. 18, 2016

(54) SYSTEMS AND METHODS FOR TRANSPORTATION SERVICES FOR PACKAGE DELIVERY

(71) Applicants: Sunil Paul, San Francisco, CA (US); Jahan Khanna, San Francisco, CA (US); Robert Wong, Burlingame, CA (US); Robert Moran, San Francisco, CA (US); Thomas Gellatly, San Francisco, CA (US)

(72) Inventors: Sunil Paul, San Francisco, CA (US); Jahan Khanna, San Francisco, CA (US); Robert Wong, Burlingame, CA (US); Robert Moran, San Francisco, CA (US); Thomas Gellatly, San Francisco, CA (US)

(21) Appl. No.: 14/573,401

(22) Filed: Dec. 17, 2014

Related U.S. Application Data
(60) Provisional application No. 62/037,445, filed on Aug. 14, 2014.

(51) Int. Cl. G06Q 10/08

(52) U.S. Cl. CPC G06Q 10/08355

(57) ABSTRACT

Systems, methods and a computer-readable medium provide for package delivery by transportation services that transport one or more passenger to desired locations. In one or more embodiments, a transportation server identifies a package delivery location for a package. The transportation server determines a route characteristic based at least on the package delivery location. The transportation server sends the route characteristic to a transportation service for transporting at least one passenger to a passenger drop-off location.

### CROSS-REFERENCE TO RELATED APPLICATIONS

This patent application claims the benefit of U.S. Provisional Patent Application Ser. No. 62/037,445, filed on Aug. 14, 2014 and entitled “SYSTEMS AND METHODS FOR IMPROVED SHARED TRANSPORTATION SERVICES AND IMPROVED QUEUED TRANSPORTATION SERVICES” which is incorporated by reference in its entirety.

### TECHNICAL FIELD

The present disclosure generally relates to transportation services and, more specifically, to systems and methods for the scheduling and routing of package deliveries.

### BRIEF DESCRIPTION OF THE DRAWINGS

Some embodiments are illustrated by way of example and not of limitation in the figures of the accompanying drawings.

FIG. 1 is a schematic diagram showing an example of a system for providing a transportation marketplace, according to some embodiments;

FIG. 2 is a block diagram showing example components of a transportation server, according to some embodiments;

FIG. 3 is a block diagram showing example components of a client device, according to some embodiments;

FIG. 4 is a flowchart showing an example method of clustering packages, according to some embodiments;

FIG. 5 is a flowchart showing an example method of filtering passenger requests, according to some embodiments;

FIG. 6 is a flowchart showing an example method of determining a rendezvous location, according to some embodiments;

FIG. 7 is a block diagram of a machine in the example form of a computer system within which a set of instructions, for causing the machine to perform any one or more of the methodologies discussed herein, may be executed, according to some embodiments.

### DETAILED DESCRIPTION

Example systems and methods for transportation services for package delivery are described. In some embodiments, the transportation service combine the scheduling of the delivery of one or more packages with dynamically determining routes to a pick-up location and a drop-off location desired by at least one passenger. The following description, for purposes of explanation, numerous specific details are set forth in order to provide a thorough understanding of example embodiments. It will be evident, however, to one skilled in the art that the present technology may be practiced without these specific details.

Embodiments described below provide for an automated method for convenient, efficient allocation of personal and package transportation and other on-demand transportation resources and transportation services over a data communications network. These embodiments may also be extended for use in a variety of scenarios in which a mobile resource requires scheduling and allocation of that resource.

A transportation server may provide an online environment in which drivers and users (e.g. passengers) may connect with one another for transportation services. The transportation server determines payments required by each passenger of a transportation service and required for delivery of one or more packages. In some embodiments, a transportation service may comprise a trip (or route) from a starting location to a destination location. In some embodiments, a transportation service may be a trip (or a dynamically modifiable route) from a pick-up location associated with a passenger and/or a package to a drop-off location associated with the passenger and/or the package.

Systems, methods and a computer-readable medium provide for package delivery by one or more transportation services that transport one or more passengers to desired locations. In one or more embodiments, a transportation server identifies a package delivery location for a package(s). The transportation server determines a route characteristic based at least on the package delivery location. The transportation server sends the route characteristic to a transportation service for transporting at least one passenger to a passenger drop-off location.

In some embodiments, it is understood that a route characteristic can refer to at least a portion of a route by which the transportation service travels in order to transport a package(s) and a passenger(s). In some embodiments, the package and passenger concurrently share at least the portion of the route.

In other embodiments, the route characteristic can refer to a geographic area (or direction) upon which a route will be based on in order for the transportation service to travel to pick-up/deliver packages and pick-up/drop-off passengers. The route characteristic can also refer to an update to a portion(s) of a current route of the transportation service. The route characteristic can also refer to a scheduled time the transportation service should travel on a particular route.

In various embodiments, the transportation server determines the route characteristic based at least on any of the following: package pick-up location, package pick-up time, package delivery location, package delivery deadline, passenger pick-up location, passenger pick-up time (such as a pre-scheduled pick-up time), passenger drop-off location, passenger desired drop-off time.

The transportation server further determines the route characteristic based at least on a current location of a particular transportation service, a distance of the current location of the particular transportation service to a pick-up location or a drop-off location of a package(s), a distance of the current location of the particular transportation service to a pick-up location or a drop-off location of a passenger(s).

In various embodiments, the transportation server further determines the route characteristic based on current traffic data, historical traffic data, as well as data indicative of various attributes of the current route of the transportation service.

In various embodiments, the transportation server further determines the route characteristic based on attributes of available transportation services. Such attributes of available transportation services comprising any of the following: start time of the transportation service's shift, end time of the transportation service's shift, current location of the transportation service, predicted location of the transportation service, current capacity of the transportation service (such as whether the transportation service is currently transporting a maximum number of packages and/or passengers).

### Clustering of Packages

In one embodiment, the transportation server identifies a plurality of packages, where each package may a different package delivery location. The transportation server analyzes each different package delivery location to identify a cluster of packages that includes packages having respective package delivery locations located along an optimal route. For example, the transportation server identifies the optimal route as including a first package delivery location and a second package delivery location by identifying a distance between the first and second package delivery locations as being at or below a threshold distance. The transportation server can further include a third package delivery location on the optimal route by identifying that a distance between the third package delivery location and at least one of the first and second package delivery locations is also at or below the threshold distance.

In other embodiments, the transportation server identifies a particular package delivery location and defines a package cluster area that encompasses the particular package delivery location. Any additional package with a package delivery location that is situated within the package cluster area is assigned to the package cluster area by the transportation server. In some embodiments, the transportation server iterates through various delivery package locations in order to identify a package delivery location that corresponds to a package cluster area in which a desired number of additional package delivery locations are also situated.

Upon determining an optimal route through multiple package delivery location, or upon determining a package cluster area, the transportation server determines a period of time during which a transportation service should be located proximate to the optimal route or in the package cluster area. For example, a transportation service may be at a current location and receiving requests from potential passengers for respective rides to a desired passenger drop-off location. The transportation server predicts a period of time during which the transportation service is most likely to receive requests from one or more as-of-yet unidentified passengers for rides to passenger drop-off locations proximate to the optimal route or within the package cluster area. The transportation server determines a package delivery time for each package in the cluster of packages to occur during the predicted period of time so that as the transportation service travels towards and through the optimal route or the package cluster area during the predicted period of time, there is a high likelihood that the transportation service will receive and be able to service requests from potential passengers that will most likely have desired passenger pick-up/drop-off locations near and/or along the optimal route—or near and/or in the package cluster area.

### Filtering of Passenger Requests

In various embodiments, the transportation server assigns a package(s) to a particular transportation service for transporting at least one passenger from a passenger pick-up location to a passenger drop-off location. The particular transportation service travels to a package delivery location to acquire the package. The transportation server defines a filter area based on at least one package delivery location that corresponds to a package to which the particular transportation service is assigned.

The transportation server detects that a current location of the particular transportation is proximate to or in the filter area defined by the transportation server. The transportation server receives a plurality of requests from potential passengers requesting trips from respective desired passenger pick-up locations to desired passenger drop-off locations. The transportation server filters those requests that correspond to a desired passenger pick-up/drop-off location that are in—or within a threshold distance from—the filtered area in which a respective package delivery location is situated.

In other embodiments, the transportation server filters those requests that correspond to a desired passenger pick-up/drop-off location located on an optimal route from the current location of the particular transportation service to the defined filter area. For example, the desired passenger pick-up/drop-off location may be within a threshold distance from a portion of a current route of the particular transportation service towards a respective package delivery location.

The transportation server sends those one or more filtered requests to the particular transportation service so that the particular transportation service can accept a filtered request from a potential passenger that has a desired passenger pick-up/drop-off location near the package delivery location of a package to which the particular transportation service is assigned.

### Dynamic Rendezvous Location

In various embodiments, the transportation server receives an indication of a vehicle to which one or more packages are currently assigned. The transportation server may also receive an indication that the vehicle is currently on a route towards a package delivery location of a respective package. The transportation server identifies a current location of the vehicle and a current location of a particular transportation service for transporting at least one passenger to a passenger drop-off location. Based on the identified respective current locations, the transportation server identifies a rendezvous location and an optimal route for both the vehicle and the particular transportation service to arrive at the rendezvous location within a given range of time. It is understood that the rendezvous location is a location that is optimally located for both the vehicle and the particular transportation service given the current locations of the vehicle and particular transportation service.

Both the vehicle and the particular transportation service travel to the rendezvous location where the package is physically moved to the custody of the particular transportation service. The transportation server receives an indication that the particular transportation service has custody of the package. The transportation server modifies a record of assignment for the package to reflect that the particular transportation service is now assigned to the package—instead of the vehicle.

It is understood that, according to various embodiments disclosed herein, the transportation server determines an optimal route(s), an optimal location(s) and an optimal area(s) with respect to a current location of transportation services, a current location of other vehicles, package delivery locations and/or current locations of one or more packages.

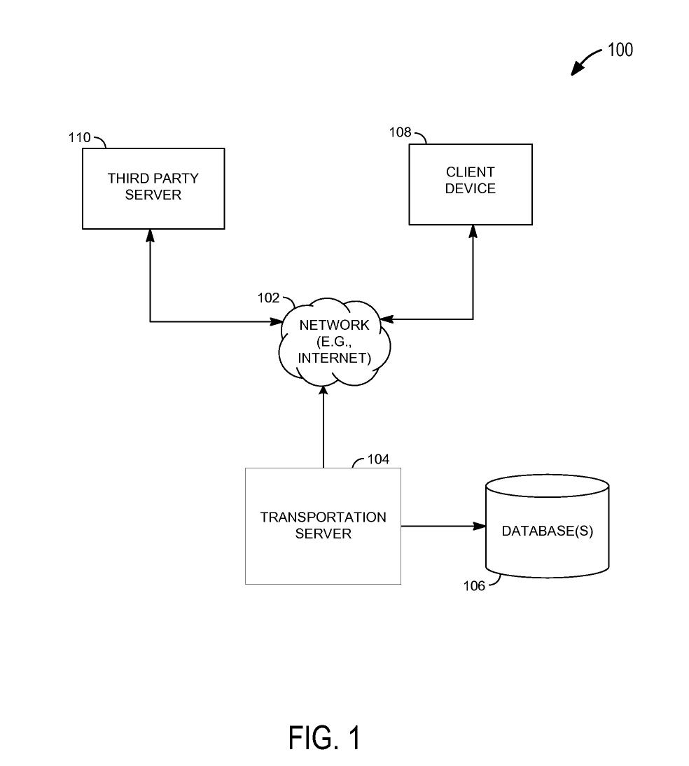

FIG. 1 is a schematic diagram showing an example of a system 100 for providing a transportation marketplace. The system 100 includes a transportation server 104, one or more client devices 108, and a third party server 110. The components of the system 100 may be connected directly or over a network 102, which may be any suitable network. In various embodiments, one or more portions of the network 102 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The transportation server 104 may include a network-addressable computing system that may facilitate communication between drivers and passengers and may obtain and utilize data relevant to drivers and/or passengers stored in the database(s) 106.

The client device 108 may be any suitable computing device that may be used by a driver and/or a passenger to communicate with one another, such as a smart phone, a personal digital assistant (PDA), a mobile phone, a personal computer, a laptop, a computing tablet, or any other device suitable for communication.

The third party server 110 may be any server that may be accessed by the transportation server 104 and/or the client device 108 to obtain information relevant to transportation services (e.g., public transportation, location-based services, etc.).

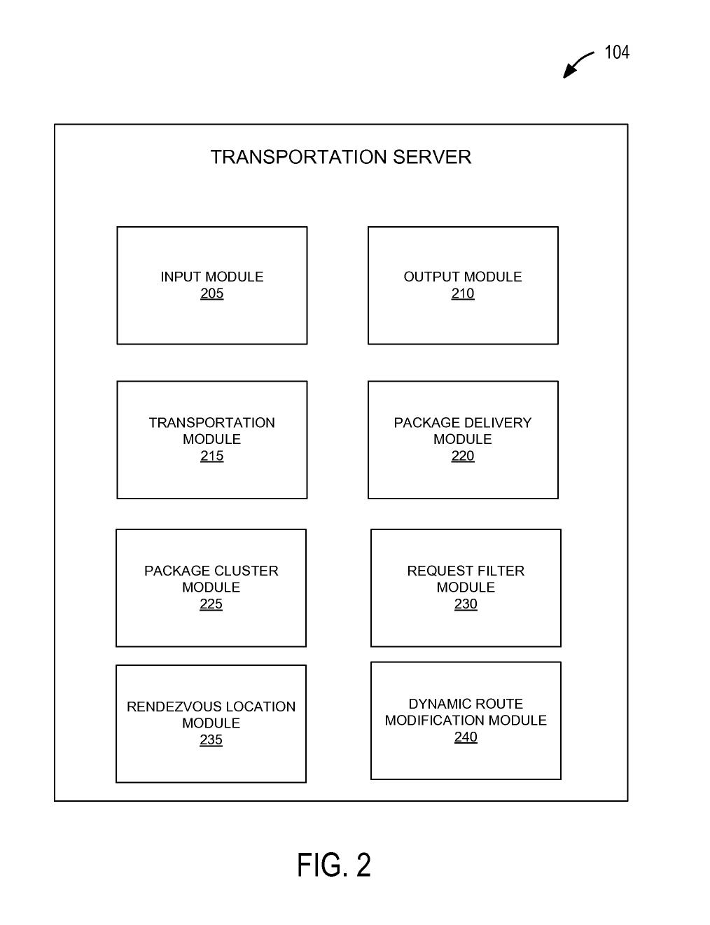

FIG. 2 is a block diagram showing example components of a transportation server 104. The transportation server 104 may include an input module 205, an output module 210, a transportation module 215, a package deliver module 220, a package cluster module 225, a request filter module 230, a rendezvous location module 235 and a dynamic route modification module 240.

The input module 205 is a hardware-implemented module to receive and process any inputs from one or more components of system 100 of FIG. 1 (e.g., one or more client devices 108, third party server 110, etc.). The inputs may include requests related to transportation, requests for transportation services, indications of a driver's computing device, payment information, identification of one or more packages and corresponding package pick-up and/or delivery locations, and the like.

The output module 210 is a hardware-implemented module to send any outputs to one or more components of system 100 of FIG. 1 (e.g., one or more client devices 108, third party server 110, etc.). The outputs may include information about available drivers (such as drivers eligible to be booked for upcoming transportation services), passengers requesting transportation, passengers requesting upcoming transportation services, identification of one or more packages and corresponding package pick-up and/or delivery locations, and the like.

The transportation module 215 is a hardware-implemented module to manage, facilitate, and control information related to transportation requests for and acceptances of transportation services from passengers and drivers, respectively.

The package delivery module 220 is a hardware-implemented module to manage, control, store, and access information associated with one or more packages. The information may be stored in and accessed from the database(s) 106 shown in FIG. 1. The information managed by the package delivery module 220 may include any information describing a package identifier, a current location of a package, a pick-up location of a package, a package delivery location, a required delivery time of a package, a third party handler of the package, and an identification of a transportation service assigned to the package.

The package cluster module 225 is a hardware-implemented module to manage, facilitate, and control information related to a package cluster area. In some embodiments, the package cluster module 225 identifies and defines a package cluster area. The package cluster module 225 identifies one or more packages that are to be included in a particular package cluster area. The package cluster module 225 predicts a period of time when one or more unidentified passengers are most likely to request respective rides in or proximate to (i.e. within a threshold distance from) the package cluster area.

The request filter module 230 is a hardware-implemented module to manage, facilitate, and control information related to filtering passenger request to a transportation service assigned to one or more packages. The request filter module 230 assigns one or more packages to a particular transportation service from a plurality of transportation services. The request filter module 230 identifies an area with respect to a delivery location of the one or packages. The filters a plurality of transportation requests from passengers in order to identify requests that are in or proximate to the area.

The rendezvous location module 235 is a hardware-implemented module to manage, facilitate, and control information related to rendezvous locations. The rendezvous location module 235 identifies a rendezvous location between a vehicle assigned to one or more packages and a particular transportation service from a plurality of transportation services. The rendezvous location module 235 identifies a rendezvous location that is a threshold distance from both a portion of a current route of the vehicle and a particular transportation service from a plurality of transportation services.

The dynamic route modification module 240 is a hardware-implemented module to manage, facilitate, determine, identify, and calculate modifications to a route of a transportation service. In some embodiments, the dynamic route modification module 240 modifies at least a portion of a current route of a transportation service towards a package cluster area. The dynamic route modification module 240 modifies at least a portion of a current route of a transportation service to include a passenger pick-up location and/or a passenger drop-off location that is in or proximate to an area that surrounds one or more package delivery locations. The dynamic route modification module 240 modifies at least a portion of a current route of a transportation service to include a rendezvous location. The dynamic route modification module 240 modifies at least a portion of a current route of a vehicle to include a rendezvous location.

Although not illustrated in FIG. 2, a user profile module may also be included in the transportation server 104. The user profile module is a hardware-implemented module to manage, control, store, and access information associated with drivers and/or passengers. The information may be stored in and accessed from the database(s) 106 shown in FIG. 1. The information managed by the user profile module may include any information associated with a driver(s), passenger(s) and/or one or more packages, such as preferences, vehicle information, background information of a driver, ratings of drivers and/or passengers, payment information of drivers and/or passengers, package locations, package delivery pick-up/drop-off times, and the like.

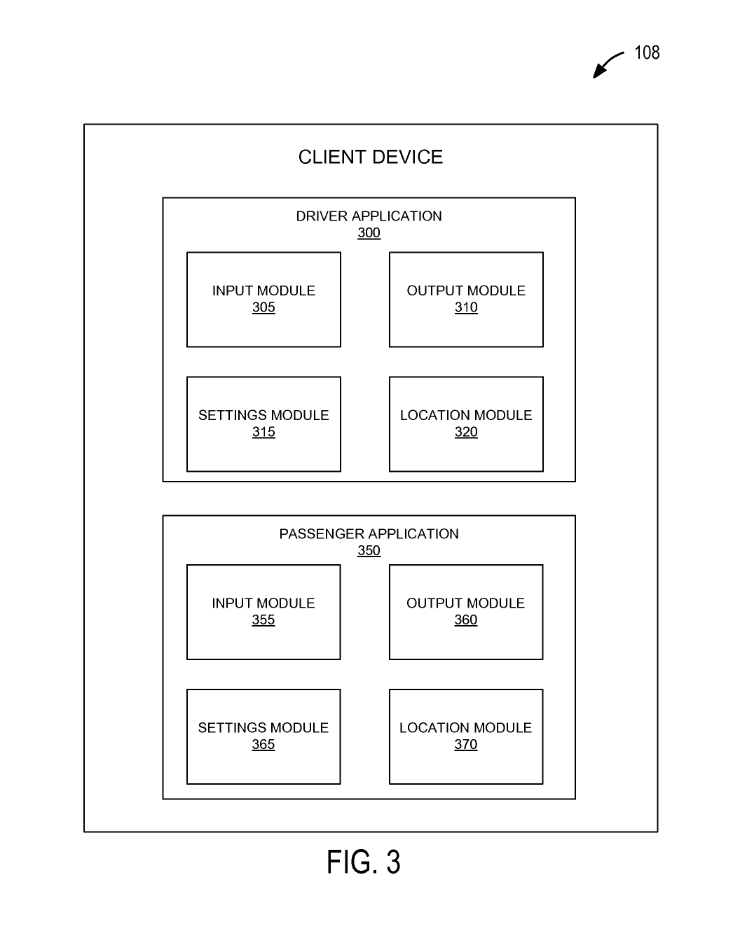

FIG. 3 is a block diagram showing example components of a client device 108. The client device may be a computing device of a driver(s) and/or a passenger(s) and may include a driver application 300 and/or a passenger application 350.

The driver application 300 is a software application associated with the transportation server 104 of FIGS. 1-2. The driver application 300 includes an input module 305, an output module 310, a settings module 315, and a location module 320.

The input module 305 is a hardware-implemented module to receive and process any inputs from a driver, including inputs related to responses to a request(s) for any kind of transportation service from one or more users (e.g. passengers), inputs related to preferences of the driver, inputs related to one or more package deliveries, and the like.

The output module 310 is a hardware-implemented module to send any outputs to one or more components of system 100 of FIG. 1 (e.g., other client devices 108, third party server 110, transportation server 104, etc.). The outputs may include indications of a current location of the client device 108, indications of a current location of the client device 108 with respect to a pick-up location(s) and/or drop-off location(s), acceptance and/or denial of requests for transportation services, indications of a current status of a schedule package delivery, and the like.

The settings module 315 is a hardware-implemented module to manage, store, and access settings indicated by a driver, such as starting location, destination location, price, a rating of a passenger, and the like.

The location module 320 is a hardware-implemented module that may determine a location of the client device 108. The location module 320 may determine a location in any suitable manner (e.g., using a third party server 110, GPS capabilities on the client device 108, etc.).

The passenger application 350 is a software application associated with the transportation server 104 of FIGS. 1-2. The passenger application 350 includes an input module 355, an output module 360, a settings module 365, and a location module 370.

The input module 355 is a hardware-implemented module to receive and process any inputs from a passenger (e.g. a user), including inputs related to a request for any kind of transportation service, inputs related to preferences of the passenger, and the like.

The output module 360 is a hardware-implemented module to send any outputs to one or more components of system 100 of FIG. 1 (e.g., other client devices 108, third party server 110, transportation server 104, etc.). The outputs may include requests for a transportation service, location of the client device 108, and the like.

The settings module 365 is a hardware-implemented module to manage, store, and access settings indicated by a passenger, such as a pick-up location, a drop-off location, a price preference, a driver rating, a driver response rate, a casual carpooling preference, a preferred estimated time of arrival, and the like.

The location module 370 is a hardware-implemented module to determine a location of the client device 108. The location module 320 may determine a location in any suitable manner (e.g., using a third party server 110, GPS capabilities on the client device 108, etc.).

### Clustering of Packages

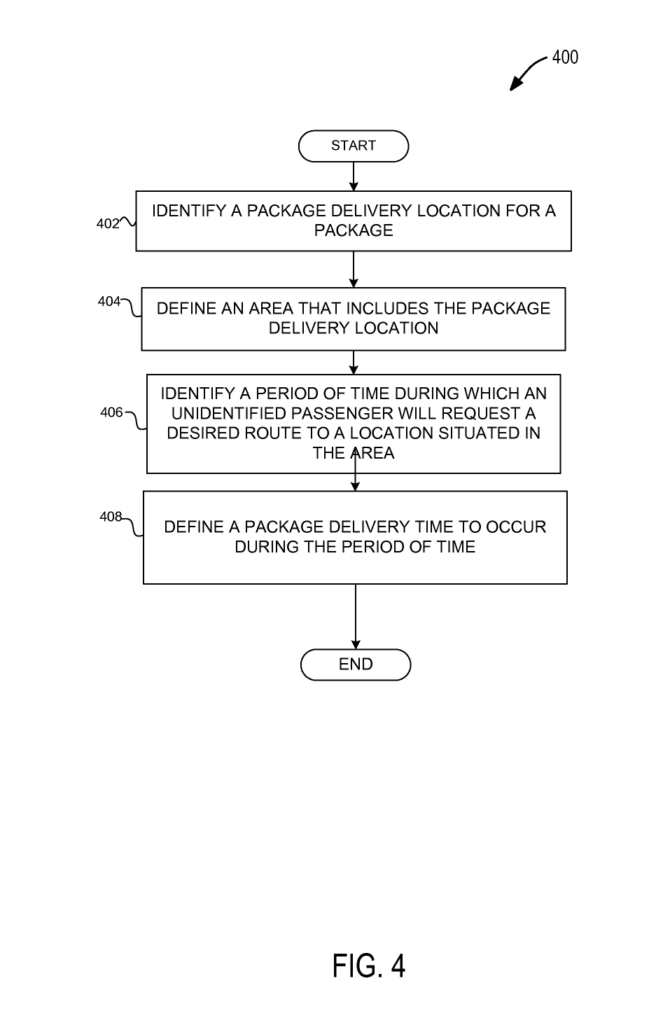

FIG. 4 is a flowchart 400 showing an example method of clustering packages, according to some embodiments.

At operation 402, the transportation server 104 identifies a package delivery location for a package. In one embodiment, a plurality of packages currently located at one or more package pick-up locations each have a package delivery location.

At operation 404, the transportation server 104 defines an area that includes the package delivery location. The transportation server 104 identifies and sorts each package delivery location to identify a cluster of packages. A cluster of packages comprises one or more packages that are to be assigned for delivery by a transportation service that can concurrently transport one or more passengers to various passenger drop-off locations.

The transportation server 104 analyzes each package delivery location to determine a package cluster area. A package cluster area comprises package delivery locations that are optimally located near each other. To define the package cluster area, the transportation server 104 accounts, in part, for at least one of: the desired delivery times of the packages, past traffic data, current traffic data, predicted traffic data and various distances between respective package delivery locations.

The transportation server 104 includes packages in the package cluster area having delivery locations that do not exceed a threshold distance from each other. For example, if a first delivery location for a first package is below the threshold distance from a second delivery location for a second package, the transportation server 104 defines the package cluster area as including the first and second delivery locations. If a third delivery location for a third package exceeds the threshold distance from one of the first and second delivery locations, the transportation server 104 does not include the third delivery location in the package cluster area.

In determining whether the package cluster area includes a delivery location for a package, in some embodiments, the transportation server 104 can account for travel time between other delivery locations in the package cluster area. Based on historical and current traffic data, the transportation server 104 determines an amount of travel time between delivery locations. If the transportation server 104 determines the calculated amount of travel time from a first delivery location of a first package to a second delivery location of a second package exceeds a threshold travel time, the second delivery location for the second package is not included in the package cluster area—even if the distance between the first and second delivery locations does not exceed the threshold distance.

The package cluster area can be further defined for a predefined number of package delivery locations. In some embodiments, the package cluster area can be defined as including only package delivery locations situated in at least a portion of a zip code area or any pre-defined geographical area.

It is further understood that packages included in the package cluster area each have a similar required delivery time. For example, if a difference between required delivery times for a first package and a second package does not exceed a threshold time amount, the transportation server 104 defines the package cluster area as including the first and second packages. If a difference between a required delivery time for a third package and one of the required delivery times for the first and second package exceeds the threshold time amount, the transportation server 104 does not include the third package in the package cluster area.

At operation 406, the transportation server 104 identifies a period of time during which an unidentified passenger will request a desired route to a location situated in the package cluster area. Given the package cluster area, the transportation server 104 predicts when potential passengers are most likely to send requests for transportation to respective passenger drop-off locations situated in the package cluster area—or located within a threshold distance from the package cluster area.

In some embodiments, in order to make such a prediction, the transportation server 104 analyzes previous passenger request data to identify various days and/or time ranges associated with a threshold increase in passenger requests for passenger drop-off locations (and/or passenger pick-up locations) in or within a threshold distance from the package cluster area.

The transportation server 104 may also analyze current event data to identify time range(s) when an increase in population activity will most likely occur in or proximate to (i.e. within a threshold distance from) the package cluster area. In other embodiments, the transportation server 104 may also analyze user data (such as previous transportation requests, pre-scheduled transportation requests, etc.) to identify time range(s) when one or more persons intend to go to a location in the package cluster area. It is understood that various other types of data can be considered by the transportation server 104.

At operation 408, the transportation server 104 defines a package delivery time to occur during the period of time. For each package in the cluster of packages, the transportation server 104 determines a package delivery time to occur during a period of time the transportation server 104 predicts that one or more unidentified passengers are likely to request transportation to respective drop-off locations in or proximate to the package cluster area.

It is understood that the package delivery time determined by the transportation server 104 does not occur after a required delivery time of any package included in the package cluster area.

With the package delivery times for packages assigned to the package cluster area occurring during the predicted period of time, the transportation server 104 increases a likelihood that as the transportation service travels towards one or more package delivery locations in the package cluster area, the transportation service will receive passenger requests for a desired drop-off location in or proximate to the package cluster area.

### Filtering of Passenger Requests

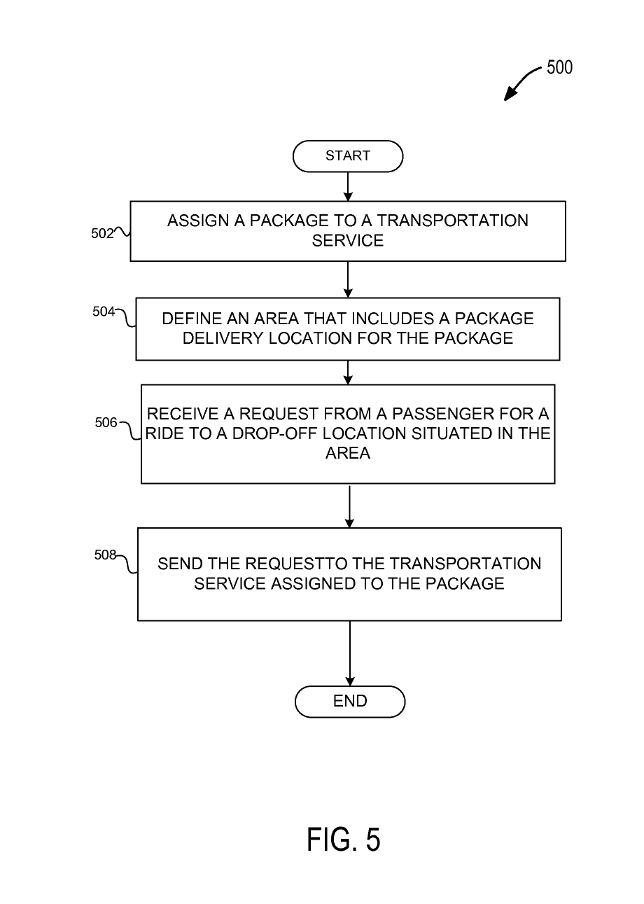

FIG. 5 is a flowchart 500 showing an example method of filtering passenger requests, according to some embodiments.

At operation 502, the transportation server 104 assigns a package(s) to a transportation service. For example, the transportation server 104 assigns a plurality of packages currently located at one or more package pick-up locations to a transportation service, where each package has a package delivery location and delivery time. The transportation service can arrive at the one or more package pick-up locations at various times and acquire each of the plurality of packages. By assigning the packages to the transportation service, the transportation server 104 creates an association between the packages and the transportation service representing the transportation service as having physical custody of the plurality of packages.

At operation 504, the transportation server 104 defines an area that includes a package delivery location for the package. In some embodiments, the transportation server 104 creates a route in a filter area the transportation service will travel, where the route includes a respective delivery location of each package assigned to the transportation service.

At operation 506, the transportation server 104 receives a request from a passenger for a ride to a desired passenger drop-off location situated in the area. In some embodiments, the transportation server 104 receives a plurality of requests from potential passengers requesting trips from respective desired passenger pick-up locations to respective desired passenger drop-off locations. The transportation server 104 sorts through the plurality of requests to identify one or more requests (hereinafter “identified requests”) that correspond to pick-up and/or drop-off locations situated in the filter area—or within a threshold distance from the filtered area.

In some embodiments, the transportation server 104 determines a current location of the transportation service along the route towards an upcoming delivery location for a package to which the transportation service is assigned. For each received request, the transportation server 104 determines whether a distance between the transportation service's current location on the route towards the upcoming delivery location and the requested passenger pick-up location does not exceed a threshold distance. The transportation server 104 further determines whether a distance between the requested passenger drop-off location and the upcoming delivery location does not exceed the threshold distance.

In addition, in some embodiments, the transportation server 104 determines whether a travel time between the transportation service's current location on the route and the requested passenger pick-up location does not exceed a threshold travel time. The transportation server 104 further determines whether a travel time between the requested passenger drop-off location and the upcoming package's delivery location does not exceed the threshold travel time.

At operation 508, the transportation server 104 sends the request to the transportation service that is assigned to the package. In various embodiments, if the threshold distance is not exceeded by pick-up/drop-off locations for a particular request, the transportation server 104 determines the particular request will be sent to the transportation service. If the threshold distance is exceeded by pick-up/drop-off locations for the particular request, the transportation server 104 determines the particular request will not be sent to the transportation service. Additionally, in some embodiments, if the threshold travel time is not exceeded, the transportation server 104 determines the particular request will be sent to the transportation service.

### Dynamic Rendezvous Location

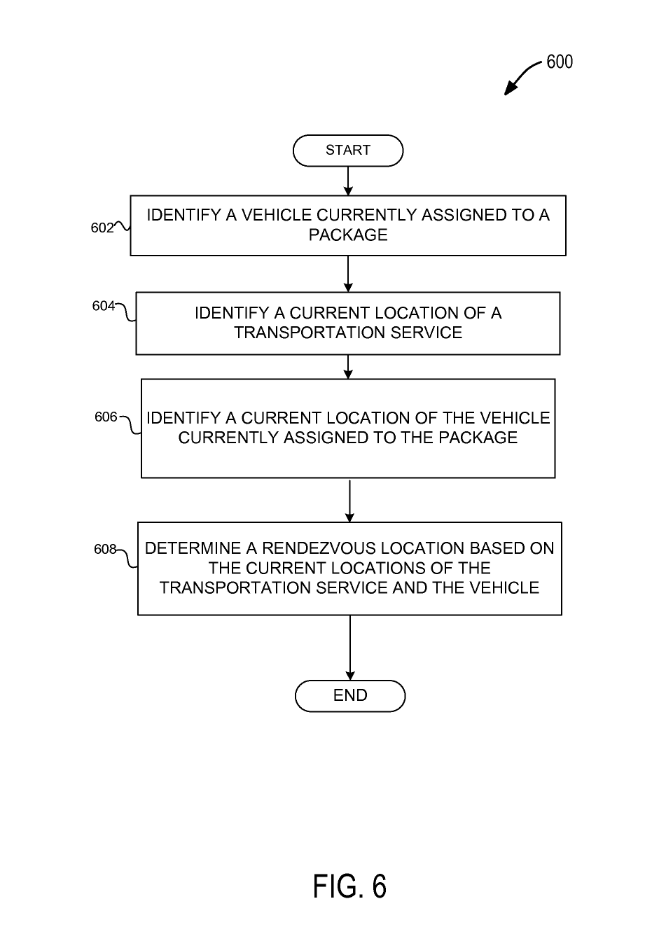

FIG. 6 is a flowchart 600 showing an example method of determining a rendezvous location, according to some embodiments.

At operation 602, the transportation server 104 identifies a vehicle currently assigned to a package. In some embodiments, the transportation server 104 receives an indication of a vehicle associated with a third party delivery service, which is currently assigned physical custody of one or more packages.

At operation 604, the transportation server 104 identifies a current location of a transportation service. In various embodiments, the transportation server 104 receives an indication of a current location of one or more transportation services. Each transportation service may be currently traveling on a route, defined by the transportation server 104, through at least one of: a passenger pick-up location(s), a passenger drop-off location(s), a package pick-up location(s) and/or a package delivery location(s).

At operation 606, the transportation server 104 identifies a current location of the vehicle assigned to the package. In various embodiments, the transportation server 104 receives an indication that the vehicle is traveling (or will be traveling) along a route to a destination—such as a package delivery location for one or more packages to which the vehicle is assigned.

At operation 608, the transportation server 104 determines a rendezvous location based on the current locations of the transportation service and the vehicle. In one embodiment, the transportation server 104 identifies a particular location and identifies a particular transportation service from a plurality of active transportation services whereby the particular location does not exceed a threshold distance from the vehicle's current location and also does not exceed the threshold distance from the particular transportation service's current location.

In another embodiment, the transportation server 104 identifies a particular location and identifies a particular transportation service from a plurality of active transportation services whereby the particular location does not exceed a threshold distance from an upcoming portion of the vehicle's current route and also does not exceed the threshold distance from an upcoming portion of the particular transportation service's current route.

In addition to considering the threshold distance, the transportation server 104 determines whether identifying the particular location as a rendezvous location adds respective additional travel time amounts to a travel time of the current route of the particular transportation service and a travel time of the current route of the vehicle. If adding the particular location to either of the current routes of the transportation service and the vehicle does not exceed incur additional travel time above a threshold travel time, the transportation server 104 determines that the particular location further qualifies as a rendezvous location between the vehicle and the particular transportation service.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

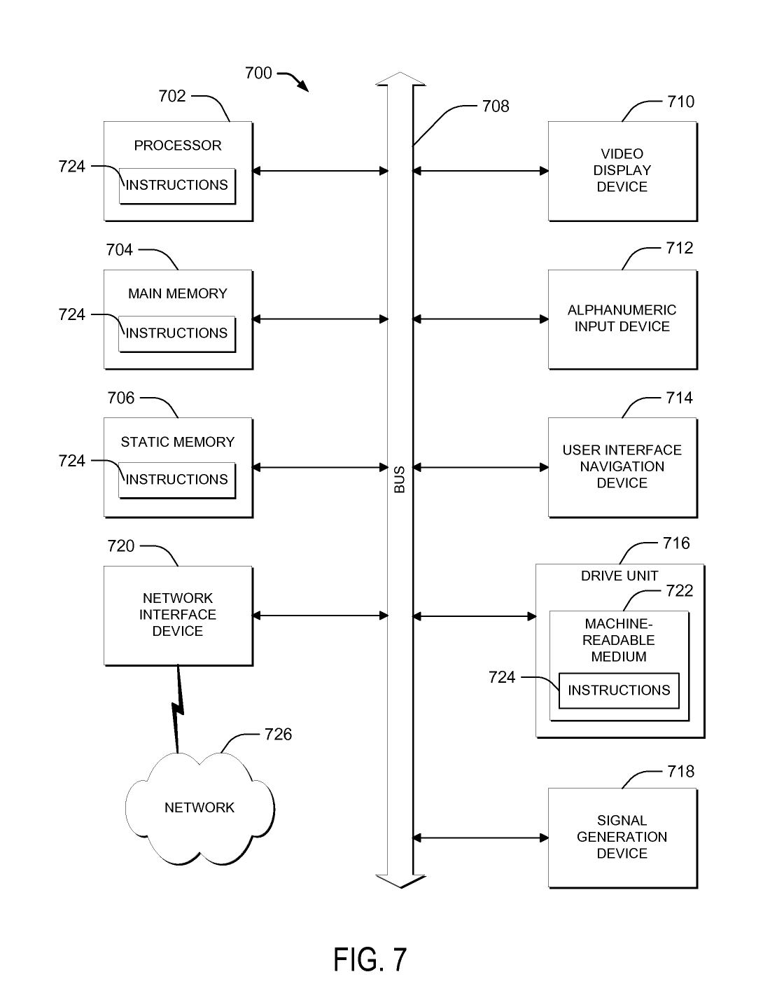

FIG. 7 is a block diagram of a machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures (e.g., software) 724 embodying or utilized by any one or more of the methodologies or functions described herein. Instructions 724 may also reside, completely or at least partially, within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method, comprising:
identifying, at a server computing device, a package delivery location for a package;
determining, at the server computing device, at least one route characteristic based at least on the package delivery location, wherein determining at least one route characteristic comprises:
defining an area that includes the package delivery location; and
identifying a predicted period of time during which at least one unidentified passenger will request a desired route to a passenger drop-off location situated in the area; and
sending, from the server computing device, the at least one route characteristic to a client device associated with a transportation service for transporting at least one passenger to a passenger drop-off location.

2. (canceled)

3. The computer-implemented method of claim 1, further comprising:
wherein identifying a package delivery location for a package comprises:
identifying a first package delivery location for a first package; and
identifying a second package delivery location for a second package; and
wherein defining an area that includes the package delivery location comprises:
defining the area as surrounding the first package delivery location and the second package delivery location.

4. The computer-implemented method of claim 1, wherein sending the at least one route characteristic to a transportation service for transporting at least one passenger to a passenger drop-off location comprises:
determining a package delivery time for the package to occur during the predicted period of time during which the at least one unidentified passenger will request the desired route to the passenger drop-off location situated in the area.

5. The computer-implemented method of claim 1, comprising:
assigning the package to a particular transportation service;
wherein determining at least one route characteristic based at least on the package delivery location:
defining an area that includes the package delivery location; and
receiving a request from a passenger for a route to a passenger drop-off location situated in the area.

6. The computer-implemented method of claim 5, wherein sending the at least one route characteristic to a transportation service for transporting at least one passenger to a passenger drop-off location comprises:
sending the request from the passenger to the particular transportation service assigned to the package.

7. The computer-implemented method of claim 1, wherein identifying a package delivery location for a package comprises:
identifying a vehicle assigned to the package currently on a route to the package delivery location.

8. The computer-implemented method of claim 7, wherein determining at least one route characteristic based at least on the package delivery location comprises:
identifying a current location of a particular transportation service for transporting at least one passenger to a passenger drop-off location;
identifying a current location of the vehicle assigned to the package; and
determining a rendezvous location based on a current location of the vehicle assigned to the package and the current location of the particular transportation service.

9. The computer-implemented method of claim 8, comprising:
sending a first route to the rendezvous location to the vehicle assigned to the package; and
wherein sending the at least one route characteristic to a transportation service for transporting at least one passenger to a passenger drop-off location comprises:
sending a second route to the rendezvous location to the particular transportation service.

10. A non-transitory machine-readable storage medium storing instructions which, when executed by one or more processors, cause the one or more processors to perform operations comprising:
identifying a package delivery location for a package;
determining at least one route characteristic based at least on the package delivery location, wherein determining at least one route characteristic comprises:
defining an area that includes the package delivery location; and
identifying a predicted period of time during which at least one unidentified passenger will request a desired route to a passenger drop-off location situated in the area; and
sending the at least one route characteristic to a transportation service for transporting at least one passenger to a passenger drop-off location.

11. (canceled)

12. The non-transitory machine-readable storage medium of claim 10, further comprising:
wherein identifying a package delivery location for a package comprises:
identifying a first package delivery location for a first package; and
identifying a second package delivery location for a second package; and
wherein defining an area that includes the package delivery location comprises:
defining the area as surrounding the first package delivery location and the second package delivery location.

13. The non-transitory machine-readable storage medium of claim 10, wherein sending the at least one route characteristic to a transportation service for transporting at least one passenger to a passenger drop-off location comprises:
determining a package delivery time for the package to occur during the predicted period of time during which the at least one unidentified passenger will request the desired route to the passenger drop-off location situated in the area.

14. The non-transitory machine-readable storage medium of claim 10, comprising:
assigning the package to a particular transportation service;
wherein determining at least one route characteristic based at least on the package delivery location:
defining an area that includes the package delivery location; and
receiving a request from a passenger for a route to a passenger drop-off location situated in the area.

15. The non-transitory machine-readable storage medium of claim 14, wherein sending the at least one route characteristic to a transportation service for transporting at least one passenger to a passenger drop-off location comprises:
sending the request from the passenger to the particular transportation service assigned to the package.

16. The non-transitory machine-readable storage medium of claim 10, wherein identifying a package delivery location for a package comprises:
identifying a vehicle assigned to the package currently on a route to the package delivery location.

17. The non-transitory machine-readable storage medium of claim 16, wherein determining at least one route characteristic based at least on the package delivery location comprises:
identifying a current location of a particular transportation service for transporting at least one passenger to a passenger drop-off location;
identifying a current location of the vehicle assigned to the package; and
determining a rendezvous location based on a current location of the vehicle assigned to the package and the current location of the particular transportation service.

18. The non-transitory machine-readable storage medium of claim 17, comprising:
sending a first route to the rendezvous location to the vehicle assigned to the package; and
wherein sending the at least one route characteristic to a transportation service for transporting at least one passenger to a passenger drop-off location comprises:
sending a second route to the rendezvous location to the particular transportation service.

19. A computer system comprising:
a processor;
a memory device holding an instruction set executable on the processor to cause the computer system to perform operations comprising:
identifying a package delivery location for a package;
determining at least one route characteristic based at least on the package delivery location, wherein determining at least one route characteristic comprises:
defining an area that includes the package delivery location; and
identifying a predicted period of time during which at least one unidentified passenger will request a desired route to a passenger drop-off location situated in the area; and
sending the at least one route characteristic to a transportation service for transporting at least one passenger to a passenger drop-off location.

20. The computer system of claim 19, further comprising:
wherein sending the at least one route characteristic to a transportation service for transporting at least one passenger to a passenger drop-off location comprises:
determining a package delivery time for the package to occur during the predicted period of time during which the at least one unidentified passenger will request the desired route to the passenger drop-off location situated in the area.
